(19) United States
(12) Patent Application Publication
(10) Pub. No.: US 2009/0140599 A1
(43) Pub. Date: Jun. 4, 2009

(54) ROTATING MACHINE

(75) Inventors: Shigeru Yoshiyama, Kariya-city (JP); Kiyoshi Kimura, Obu-city (JP); Taku Itoh, Chita-gun. (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/325,385

(22) Filed: Dec. 1, 2008

(30) Foreign Application Priority Data
Dec. 3, 2007 (JP) 2007-312711

(51) Int. Cl. H02K 1/14

(52) U.S. Cl. 310/217

(57) ABSTRACT

A thin plate 80x forming a stator tooth 80 has two convex portions 83 on each of side faces 80b, 80c. Four convex portions 83 are a sharpened convex portion 83a of which a tip portion has a thickness thinner than a thickness of the thin plate 80x. When a bobbin 81 wound with an exciting coil 22 is press-fitted around the stator tooth 80, four lines of convex portions formed by laminating the thin plates 80x cut in an inner wall of the bobbin 81, the strength for fixing and holding the bobbin 81 can be increased in a radial, lamination and rotating directions, so that the position of the bobbin 81 assembled in a right position can be maintained.

### CROSS REFERENCE TO RELATED APPLICATION

This application is based on and claims priority from Japanese Patent Applications No. 2007-312711 filed on Dec. 3, 2007, the contents of which are incorporated herein by reference.

### FIELD OF THE INVENTION

This invention relates to an electric rotating machine (hereinafter, referred to as a rotating machine) such as a motor or generator, specifically to an assembling technique of a stator coil wound around stator teeth

### BACKGROUND OF THE INVENTION

In a conventional rotating machine, a stator coil (hereinafter, referred to as a coil) is formed by directly winding an enameled wire around each of plural stator teeth. However, because it is difficult to wind the coil around the stator teeth, there is a problem of low productivity. Also, because the conventional rotating machine has a structure difficult to wind the coil, there is another problem that a space factor of the coil relative to the stator teeth becomes low.

To solve the problems, it is suggested that, firstly, the coil is wound around a bobbin made of resin, and then the bobbin wound with the coil is fitted around the stator tooth (for example, U.S. Pat. No. 6,911,798).

In order to fit the bobbin around the stator tooth, one possible technique is to press-fit the bobbin onto the stator tooth by making the fitting width of the bobbin narrower than the width of the stator tooth and another possible technique is to fit the bobbin onto the stator tooth by making the fitting width of the bobbin wider than the width of the stator tooth.

However, in the former technique, resin burrs are produced as a result that the bobbin made of resin is scraped by the stator tooth made of metal in press-fitting, and there is a possibility of causing inferior operation of the rotating machine due to the fall of the resin burrs.

In the later technique, because the bobbin is easy to move relative to the stator tooth, there is a possibility of causing poor assembling.

In order to solve the above-described problems, the combination of the former and the later techniques, that is, partial press-fitting of the bobbin and the stator tooth can be considered. Under this consideration, a trial product shown in FIGS. 6A˜6D is manufactured (it is not a prior art). It is to be noted that common reference numbers are given to the elements having the same functions as the embodiment described later. In the following description, a “rotating direction” is a direction that the rotating machine rotates. A “lamination direction” is a direction along which thin plates composing a stator core are laminated, and a direction of a rotation axis in the rotating machine.

In the trial product shown in FIGS. 6A˜6D, two convex portions 83 are formed in the thin plate 80x composing the stator tooth 80 by press cutting, the bobbin 81 is press-fitted around the stator tooth 80 having two lines of the convex portions 83 formed by laminating thin plates 80x, and thereby, the stator core 21 can have a strength for fixing and holding the bobbin 81.

Furthermore, in the trial product shown in FIGS. 6A˜6D, a stripe-shaped convex portion 90 extending in a radial direction of the rotating machine is formed on an inner face of the bobbin 81 in the lamination direction, the stator tooth 80 is press-fitted into the bobbin 81 having the stripe-shaped convex portion 90, and thereby, backlash of the bobbin in the lamination direction is absorbed by the convex portion 90.

However, the following problems occur in the trial product shown in FIGS. 6A˜6D. The strength for fixing and holding the bobbin 81 is week with the two lines of the convex portions 83 formed in the stator tooth 80. Specifically, because the line of the convex portions 83 forms a continuous surface in the lamination direction when the thin plates 80x are laminated, the convex portion 83 can not cut into the bobbin 81 and the tip of the convex portion 83 is easy to slip on the bobbin 81, and thereby the strength for fixing and holding the bobbin 81 is week in the radial and lamination directions. That is, the bobbin 81 is easy to incline and to be shifted in the radial direction.

In addition, when the stripe-shaped convex portion 90 is formed on the bobbin 81 to absorb the backlash in the lamination direction, it is necessary to set an overlapping width for press-fitting between the stripe-shaped convex portion 90 and the stator tooth 80. In this case, resin burrs are produced due to the stripe-shaped convex portion 90 scraped by the stator tooth 80 in press-fitting, and thereby, there is a possibility of causing inferior operation due to the fall of the resin burrs.

### SUMMARY OF THE INVENTION

It is therefore an object of the present invention to provide a rotating machine wherein a bobbin can be assembled in a right position onto a stator core and the strength for fixing and holding the bobbin assembled on the stator core can be increased, and thereby, the position of the bobbin assembled rightly can be maintained.

In the rotating machine according to the present invention, a thin plate of a portion forming a stator tooth has two or more convex portions at a first tooth side face and one or more convex portion at a second tooth side face. By laminating the thin plates, the stator tooth is provided with two or more lines of convex portions at the first tooth side face and one or more line of the convex portions at the second tooth side face. That is, the stator tooth formed by laminating the thin plates is provided with three or more lines of convex portions. By this means, because a bobbin is supported onto the stator tooth with three or more lines of the convex portions, the stator tooth can prevent inclination of the bobbin (bobbin inclination prevention effect). In addition, because three or more lines of the convex portions are provided in the stator tooth, the strength for fixing and holding the bobbin can be increased (first holding strength increment effect).

At least one of plural convex portions formed in the thin plate is a sharpened convex portion and has a thickness of a tip portion thinner than a thickness of the thin plate. Therefore, by laminating the thin plates, a concavity and convexity are alternately created in the lamination direction due to the sharpened convex portions.

The tip of the sharpened convex portion cuts into the bobbin. A plurality of the sharpened convex portions is lined up along the lamination direction, and they cut into the bobbin, respectively. For this reason, the bobbin can be prevented from being shifted in the lamination direction (bobbin lamination direction shift prevention effect) In addition, the strength for fixing and holding the bobbin can be increased by many sharpened convex portions cutting into the bobbin (second holding strength increment effect).

As described above, in the rotating machine according to the present invention, because the stator tooth is provided with three or more lines of convex portions and many sharpened convex portions lined in the lamination direction cut into the bobbin, the bobbin can be assembled in a right position on the stator core and the strength for fixing and holding the bobbin assembled on the stator core can be increased, and thereby, the position of the bobbin assembled in the right position can be maintained.

Further, in the rotating machine according to the present invention, an overlapping width for press-fitting the bobbin around the stator tooth is an overlapping width between the convex portions and the bobbin. Because the bobbin is inserted along layers of the laminated thin plates, smooth assembling can be realized. That is, the assembly of the bobbin can be easily carried out.

In addition, because the bobbin can be prevented from being shifted in the lamination direction as the result that many sharpened convex portions lined in the lamination direction cut into the bobbin, the stripe-shaped convex portion used in the trial product can be omitted. Therefore, there is no trouble of occurrence of resin burrs when the bobbin is assembled onto the stator core. In this way, because resin burrs are not produced, inferior operation due to the fall of the resin burrs is not caused, and thereby, reliability of the rotating machine can be enhanced.

The sharpened convex portion may be formed by plastic deformation working due to pressurized press. With the pressurized press, the sharpened convex portion can be formed at a low working cost.

It is preferable that the rotating machine has a stator housing for accommodating a stator composed of the stator core and the stator coil and bus bars supported on the stator housing for energizing the stator coil, and the bobbin has bobbin terminals connected to both ends of the stator coil respectively, wherein the bus bars supported on the stator housing conform to the bobbin terminals supported by the bobbin when the stator is installed in the stator housing. By this means, a connection process between the bus bar and the bobbin terminal can be easily and reliably carried out.

These and other features and advantages of the present invention will become more apparent upon reading the following detailed description and upon reference to the accompanying drawings.

### BRIEF DESCRIPTION OF THE DRAWINGS

FIG. 1A is an explanation diagram of a stator tooth and a bobbin before assembling viewed from the above in an axis direction of a rotating machine;

FIG. 1B is a side view of a thin plate forming the stator tooth;

FIG. 1C is an explanation diagram of the stator tooth and the bobbin after assembling viewed from the above in the axis direction;

FIG. 1D is an explanation diagram of the stator tooth and the bobbin after assembling viewed from a rotation center of the rotating machine;

FIG. 2 is a system diagram of a shift range switching apparatus;

FIG. 3 is a perspective view of an assembly of a parking switching unit and a shift range switching unit;

FIG. 4 is a cross-sectional view of a rotary actuator;

FIG. 5 is a view of a rear cover assembled with the stator viewed from a front side;

FIG. 6A is an explanation diagram of a stator tooth and a bobbin before assembling viewed from the above in an axis direction of a rotating machine as a trial product;

FIG. 6B is a side view of a thin plate forming the stator tooth in the trial product;

FIG. 6C is an explanation diagram of the stator tooth and the bobbin after assembling viewed from the above in the axis direction of the rotating machine as the trial product; and

FIG. 6D is an explanation diagram of the stator tooth and the bobbin after assembling viewed from a rotation center of the rotating machine as the trial product.

### DETAILED DESCRIPTION OF THE PREFERRED EMBODIMENTS

A rotating machine according to an embodiment has a stator core which is formed by laminating many thin plates and has a plurality of stator teeth extending toward an inward or outward radial direction, and stator coils provided to each of the stator teeth. The stator coil is wound around a bobbin made of resin, and the bobbin is fitted around the stator tooth.

A thin plate of a portion forming a stator tooth has a tooth tip face positioned at an edge in the radial direction and extending along the rotating direction, a first tooth side face extending along the radial direction from one end of the tooth tip face, and a second tooth side face extending along the radial direction from another end of the tooth tip face.

On the first and second tooth side face, convex portions projecting in the rotating direction and press-fitted to the bobbin are formed. Two or more convex portions are formed on the first tooth side face, and one or more convex portion is formed on the second tooth side face. At least one of plural convex portions is a sharpened convex portion and has a thickness of a tip portion thinner than a thickness of the thin plate.

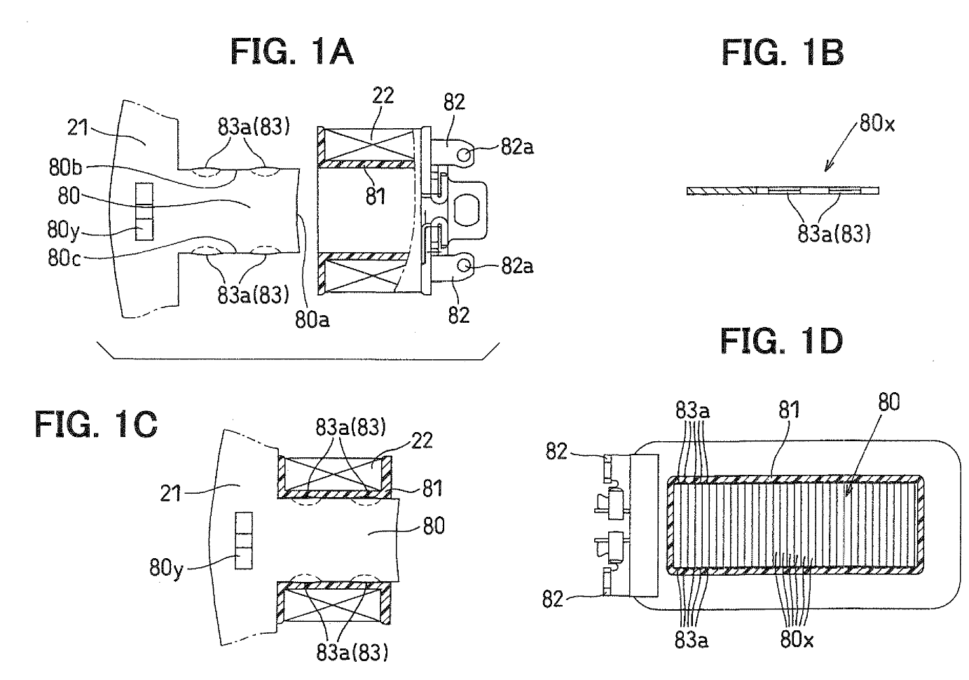

The embodiment in which the rotating machine according to the present invention is applied to an electric motor of a rotary actuator used in a shift range switching apparatus will be described with reference to FIG. 1 to FIG. 5.

### (Description of Shift Range Switching Apparatus)

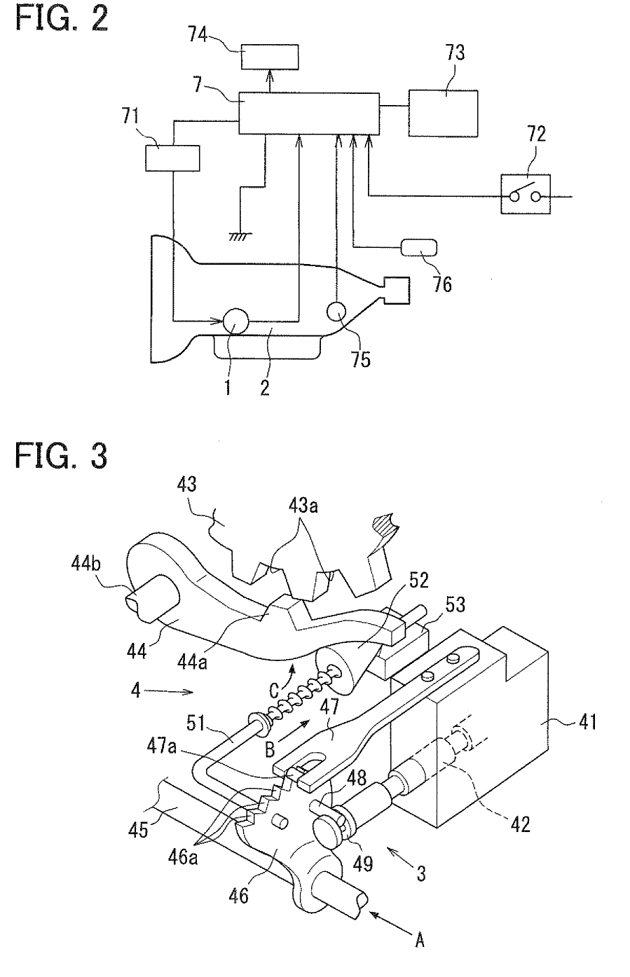

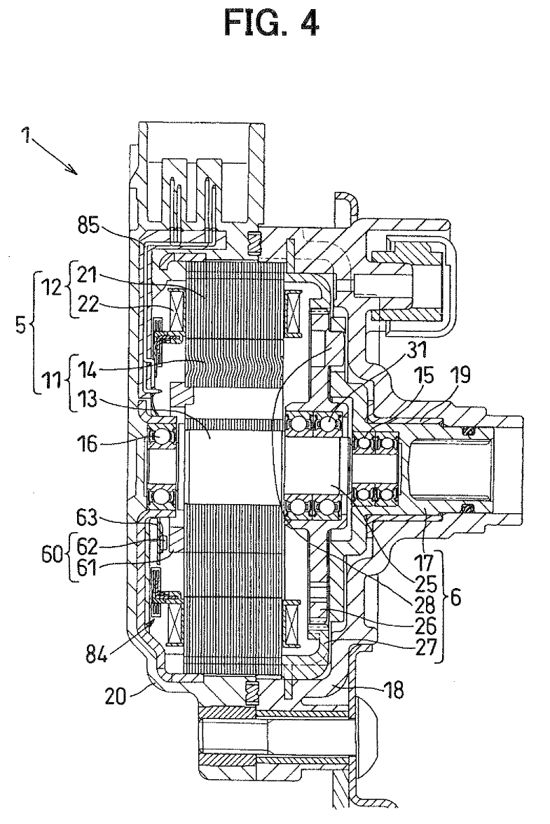

The shift range switching apparatus switches a shift range switching unit 3 and a parking switching unit 4 (see FIG. 3) mounted on a vehicular automatic transmission 2 (see FIG. 2) by the rotary actuator 1 (see FIG. 4).

The rotary actuator 1 forms a servo mechanism for driving the shift range switching unit 3 and, as shown in FIG. 4, is composed of a synchronous electric motor 5 and a reduction gear unit 6 for reducing a rotation speed of the electric motor 5. A SBW ECU 7 as shown in FIG. 2 controls the rotation of the electric motor 5. That is, the shift range switching apparatus carries out switching control of the shift range switching unit 3 and parking switching unit 4, which are driven via the reduction gear unit 6 by the SBW ECU 7 controlling a rotating direction, a number of rotations, and rotation angle of the electric motor 5.

Next, a detailed structure of the shift range switching apparatus will be described. It is to be noted that, in the following description, the rotary actuator 1 is explained while defining a right side of FIG. 4 as a front side and a left side of FIG. 4 as a rear side, but such definitions have no relation with an actual mounting direction.

(Description of Electric Motor 5)

The electric motor 5 will be explained with reference to FIG. 4. The electric motor 5 of this embodiment is a brushless SR motor (switched reluctance motor) and composed of a rotor 11 supported rotatably, and a stator 12 disposed on a same axis as a rotation center of the rotor 11.

The rotor 11 is composed of a rotor shaft 13 and a rotor core 14. The rotor shaft 13 is rotatably supported by ball bearings arranged at a front and rear ends (front ball bearing 15, rear ball bearing 16). The front ball bearing 15 is fitted and fixed in an inside wall of an output shaft 17 of the reduction gear unit 6. The output shaft 17 of the reduction gear unit 6 is rotatably supported by a metal bearing 19 arranged at an inside wall of a front housing 18. That is, the front end of the rotor shaft 13 is rotatably supported via the metal bearing 19 provided in the front housing 18, the output shaft 17 and the front ball bearing 15.

A supporting section of the metal bearing 19 in an axis direction is set so as to overlap with a supporting section of the front ball bearing 15 in the axis direction. By this means, an inclination of the rotor shaft 13 caused by reaction force of the reduction gear unit 6 (in more details, reaction force of load imposed on contact of a sun gear 26 and a ring gear 27 described later) can be prevented.

The rear ball bearing 16 is press-fitted and fixed on a periphery of a rear end of the rotor shaft 13 and supported by a rear housing (stator housing) 20.

The stator 12 is composed of a stator core 21 fixed in a housing (front housing 18+rear housing 20) and plural phases of exciting coils 22 generating magnetic force when electric power is supplied (energized).

The stator core 21 is formed by laminating a plurality of thin plates 80x (see FIG. 1) obtained by stamping out a thin plate made of iron into a predetermined shape by press working and is fixed to the rear housing 20. It is to be noted that the reference number “80y” in FIG. 1 represents embossed portions for location (lamination hollow) formed in the respective thin plates 80x.

In more details, stator teeth 80 are formed in the stator core 21 so as to project toward an inside rotor core 14 at each predetermined angle (for example, each 30 degrees). Each of stator teeth 80 is provided with the exiting coil 22 generating the magnetic force. The assembling of the exciting coil 22 to the stator tooth 80 will be described later.

An example of the exciting coil 22 will be explained. The electric motor 5 has two sets of exciting coils 22. There are U phase, V phase and W phase exciting coils 22 in each set. Generating torque of the electric motor 5 is controlled by switching first energizing control for energizing the exciting coil 22 in only one set and second energizing control for energizing the exciting coils 22 in both sets. It is to be noted that the SBW ECU 7 controls the energizing of exciting coils 22.

The rotor core 14 is formed by laminating a plurality of thin plates obtained by stamping out a thin plate made of iron into a predetermined shape by press working and is fixed to the rotor shaft 13. Rotor teeth are formed in the rotor core 14 so as to project toward the outside stator core 21 at each predetermined angle (for example, each 45 degrees).

When the SBW ECU 7 sequentially switches an energizing position and direction of the exciting coils 22, the stator teeth 80 magnetically drawing the rotor teeth are sequentially changed, and thereby, the rotor 11 rotates in one direction or the other direction.

(Description of Reduction Gear Unit 6)

Next, the reduction gear unit 6 will be explained. The reduction gear unit 6 of this embodiment is an internal engagement planetary reduction gear (cycloid reduction gear) that is a kind of a planetary reduction gear. The reduction gear unit 6 has a sun gear (inner gear: external tooth gear) 26 attached to the rotor shaft 13 via an eccentric portion 25 provided in the rotor shaft 13 and eccentrically rotating, a ring gear (outer gear: internal tooth gear) 27 with which the sun gear 26 inscribes and engages, and a transmission means 28 transmitting only a rotation component of the sun gear 26 to an output shaft 17.

The eccentric portion 25 is an axis for making the sun gear 26 rotate eccentrically relative to a rotation center of the rotor shaft 13. The eccentric portion 25 rotatably supports the sun gear 26 via a sun gear bearing 31 disposed on a periphery thereof. As described above, the sun gear 26 is rotatably supported by the eccentric portion 25 of the rotor shaft 13 via the sun gear bearing 31, and rotates in a state of being pressed onto the ring gear 27 when the eccentric portion 25 rotates. The ring gear 27 is fixed to the front housing 18.

The transmission means 28 is composed of plural inner pin holes formed on the same circumference in a flange rotating together with the output shaft 17 and plural inner pins formed in the sun gear 26 and fitted in the inner pin holes respectively. The plural inner pins are formed in a front face of the sun gear 26 so as to project the refrom. The plural inner pin holes are formed in the flange provided at the rear end of the output shaft 17. By fitting the inner pins into the inner pin holes, the rotation movement of the sun gear 26 is transmitted to the output shaft 17.

When the rotor shaft 13 rotates and the sun gear 26 eccentrically rotates, the sun gear 26 rotates at a reduced speed relative to the rotor shaft 13, and the rotation of the reduced speed is transmitted to the output shaft 17. The output shaft 17 is connected to a control rod 45 (described later) for driving and operating the shift range switching unit 3 and parking switching unit 4.

It is to be noted that, differently from the embodiment described above, plural inner pin holes may be formed in the sun gear 26 and plural inner pins may be provided in the flange.

(Description of Shift Range Switching Unit 3 and Parking Switching Unit 4)

The shift range switching unit 3 and parking switching unit 4 are driven and switched by the output shaft of the rotary actuator 1 (specifically, the output shaft 17 of the reduction gear unit 6).

The shift range switching unit 3 controls an engagement state of an oil hydraulic clutch (not shown) by sliding a manual spool valve 42 provided in a hydraulic valve body 41 at an adequate position in accordance with a shift range so as to switch oil supplying paths to the hydraulic clutch of the automatic transmission 2.

The parking switching unit 4 carries out a changeover of a lock (parking state) and unlock (parking release state) of a parking gear 43 by a park pole 44 rotatably supported on a fixed portion (for example, a housing of the automatic transmission 2) engaging with or disengaging from a parking gear 43 interlocked with a drive shaft of a vehicle and rotating together. In more details, by an engagement or disengagement between a notch 43a of the parking gear 43 and a projecting portion 44a of the park pole 44, the changeover of the lock and unlock of the parking switching unit 4 is carried out. When the rotation of the parking gear 43 is interrupted by the park pole 44, driving wheels of the vehicle are locked via a drive shaft, differential gear and so on, so that a parking state of the vehicle is achieved.

A fan-shaped detent plate 46 is attached on a control rod 45 driven by the rotary actuator 1 so that the control rod 45 and the detent plate 46 rotate together. The detent plate 46 has a plurality of notches 46a on a tip portion in a radial direction (a circular arc portion of a fan shape). When an engagement portion 47a provided at a front end of a detent spring 47 fixed on the hydraulic valve body 41 (or an inside of the automatic transmission 2) engages with one of notches 46a, selected shift range is maintained. Although a detent mechanism using a plate spring 47 is shown in this embodiment, other detent mechanism using a coil spring and so on may be employed.

The detent plate 46 has a pin 48 for driving the manual spool valve 42. The pin 48 fits in an annular groove 49 formed at an end of the manual spool valve 42. When the detent plate 46 is rotated by the control rod 45, the pin 48 is driven so as to draw a circular arc, so that the manual spool valve 42 engaging with the pin 48 moves straight inside the hydraulic valve body 41.

If the control rod 45 rotates clockwise when viewed from a direction of an arrow A in FIG. 3, the pin 48 pushes the manual spool valve 42 into the inside of the hydraulic valve body 41 so that the oil paths in the hydraulic valve body 41 are changed in the order of D, N, R, and P. That is, the shift range of the automatic transmission 2 is changed in the order of D, N, R, and P.

If the control rod 45 rotates counterclockwise, the pin 48 pulls the manual spool valve 42 out of the hydraulic valve body 41 so that the oil paths in the hydraulic valve body 41 are changed in the order of P, R, N, and D. That is, the shift range of the automatic transmission 2 is changed in the order of P, R, N, and D.

A park rod 51 is attached to the detent plate 46 to drive the park pole 44. A conical head 52 is provided at a front end of the park rod 51. The conical head 52 is positioned between a projecting portions 3 of a housing of the automatic transmission 2 and the park pole 44. If the control rod 45 rotates clockwise to change the shift range from R to P when viewed from the direction of the arrow A in FIG. 3, the park rod 51 moves along a direction of an arrow B in FIG. 3, so that the conical head 52 raises the park pole 44. At this time, the park pole 44 turns about an axis 44b in a direction of an arrow C in FIG. 3, so that the projecting portion 44a of the park pole 44 fits in one of the notches 43a of the parking gear 43. By this means, a lock state of the parking switching unit 4 (parking state) is achieved.

If the control rod 45 rotates counterclockwise to change the shift range from P to R, the park rod 51 is pulled back in a direction opposite to the direction of the arrow B in FIG. 3, so that biasing force for raising the park pole 44 disappears. Because the park pole 44 is biased by a coil spring (not shown) in a direction opposite to the direction of the arrow C in FIG. 3, the projecting portion 44a of the park pole 44 disengages from one of the notches 43a of the parking gear 43. As a result, the parking gear 43 becomes free, and an unlock state of the parking switching unit 4 (parking release state) is achieved.

(Description of Encoder 60)

As shown in FIG. 4, in the above-described rotary actuator 1, an encoder 60 for detecting a rotation angle of the rotor 11 is mounted within the housing (front housing 18+rear housing 20). By detecting the rotation angle of the rotor 11 by the encoder 60, the electric motor 5 can be driven at a high speed without causing loss of synchronism.

The encoder 60 is an increment type and is composed of a permanent magnet 61 rotating together with the rotor 11 and hole ICs 62 which are disposed so as to face to the magnet 61 in the rear housing 20 and detect the passage of a magnetic flux generating portion in the magnet 61 (for example, a magnetic detection hole IC for detecting magnetic fluxes from multi-polarized portions in the magnet 61, an index signal hole IC for detecting a magnetic flux generated each time electricity supply makes a round of each phase of the exciting coils 22 and so on) The hole ICs 62 are supported by a substrate 63 fixed in the rear housing 20.

(Description of SBW ECU 7)

The SBW ECU 7 will be explained in reference with FIG. 2. The SBW ECU 7 carries out an energizing control of the electric motor 5. The SBW ECU 7 has a well-known microcomputer composed of a CPU performing control processing and arithmetic processing, storing means (ROM, RAM, SRAM, EEPROM and so on) for storing various programs and data, an input circuit, an output circuit, a power supply circuit, and soon. The SBW ECU 7 outputs a control signal to a coil energizing circuit 71 which energizes each phase of the exciting coils 22, based on the arithmetic results.

It is to be noted that a number “72” represents an ignition switch (driving switch), a number “73” represents a vehicular battery, a number “74” represents a display device for displaying a state of the shift range switching unit (switching state of the shift range) to a driver, a number “75” represents a vehicle speed sensor, a number “76” represents sensors for detecting vehicular states, including a shift range position set by the driver, a brake switch, and so on.

The SBW ECU 7 has various control programs such as rotor read means (program) for calculating a rotation speed, a number of rotations, a rotation angle of the rotor 11 from the output of the encoder 60, normal control means (program) for controlling the electric motor 5 so that the shift range position detected by the SBW ECU 7 coincides with the shift range position set by shift range operation means (not shown) operated by the driver, hit learning means (program) for carrying out “P-wall hit learning” in which the electric motor 5 is rotated on a parking setting side when a predetermined driving condition is met (for example, the ignition switch 72 is turned on) in order to detect a reference position of the rotor 11.

### Features of the Embodiment

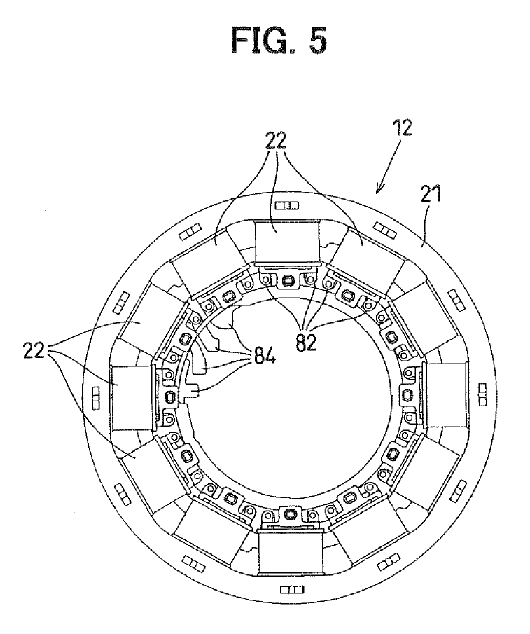

Next, the assembling of the exciting coil 22 (one example of the stator coil) disposed so as to be wound around the stator tooth 80 will be explained in reference with FIG. 1A˜1D, FIG. 4, and FIG. 5.

In order to increase a space factor of the coil relative to the stator teeth 80 and make the assembling of the coil easier, first, the exciting coil 22 is formed by an enameled wire (insulating coating conductive wire) wound many times around a bobbin 81 made of insulating resin, and then the bobbin 81 wound with the exciting coil 22 is fitted around the stator tooth 80.

The assembling of the exciting coil 22 will be explained in more details. Initially, bobbin terminals 82 are assembled in two terminal insertion portions formed on the resin-made bobbin 81, respectively. The bobbin terminal 82 is provided with a connection portion 82a which has a projecting shape and is electrically connected to a bus bar 84 fixed to the rear housing 20. In the bobbin 81, a groove is formed to start winding of the exciting coil 22, so that the enameled wire of the winding starting portion is buried in the bobbin 81.

Next, the exciting coil 22 is formed by the enameled wire wound around the bobbin 81. The both ends of the exciting coil 22 are electrically connected to two bobbin terminals 82, respectively. In this embodiment, fusing is employed as means for the electrical connection

The bobbin 81 has a tube portion of a rectangular shape in cross section, which fits around the stator tooth 80, and collar portions provided at the both ends of the tube portion. The bobbin 81 is made of well-known resin material such as nylon resin.

A dimension of an internal diameter of the tube portion in the bobbin 81 is a dimension such that the tube portion can fit around the stator tooth 80. In more details, the internal diameter of the tube portion is larger by 0.1 mm than the external diameter of the stator tooth 80. In addition, when the lamination length of the stator tooth 80 is L1 and the width of the stator tooth 80 in the rotating direction is L2, the inside length of the tube portion along the lamination direction may be L1+0.2 mm and the inside width of the tube portion along the rotating direction may be L2+0.2 mm.

Next, the bobbin 81 wound with the exciting coil 22 is fitted around each stator tooth 80 of the stator core 21 formed by laminating a large number of thin plates 80x, Each stator tooth 80 has bobbin fixing means for accurately maintaining the assembled position of the bobbin 81 and preventing inclination in the rotating direction or movement in the radial direction.

The bobbin fixing means is formed in the thin plates 80x composing each stator tooth 80. Here, in the thin plate 80x of a portion forming the stator tooth 80, an face positioned at an edge in the radial direction and extending along the rotating direction is referred to as a tooth tip face 80a, a side face extending along the radial direction from one end of the tooth tip face 80a is referred to as a first tooth side face 80b, and a side face extending along the radial direction from another end of the tooth tip face 80a is referred to as a second tooth side face 80c.

Each of the first and second tooth side faces 80b, 80c, has convex portions 83 which project in the rotating direction (width direction of the stator tooth 80) and is pressfitted into the bobbin 81. A projecting amount (blister amount in the rotating direction) of the convex portion 83 is larger than an assembling clearance between the stator tooth 80 and the bobbin 81.

For example, if the assembling clearance between the stator tooth 80 and the bobbin 81 is 0.1 mm, the projecting amount of the convex portion 83 is set to 0.2 mm˜0.6 mm so that the overlap width for press-fitting is ensured by 0.1 mm˜0.5 mm. However, the dimension of the convex portion 83 as described above is merely one example, the projecting amount of the convex portion 83 is actually set in accordance with the material, thickness, and hardness of the bobbin 81 and so on.

As shown in FIG. 1A, two convex portions 83 are formed on both the first tooth side face 80b and the second tooth side face 80c. As shown in FIG. 1B, each of the convex portions 83 in this embodiment is a sharpened convex portion 83a of which the tip is sharpened and has a thickness of a tip portion thinner than a thickness of the thin plate 80x. The thickness of the tip portion is set to a thickness such that the sharpened convex portion 83a can cut in the inner wall of the bobbin 81 by a minute amount or more when the sharpened convex portion 83a is press-fitted in the bobbin 81.

The sharpened convex portion 83a is formed by plastic deformation working due to pressurized press. That is, two places near each of the first and second tooth side faces 80b, 80c are locally pressurized. As a result, the sharpened convex portions 83a are formed on the first and second tooth side faces 80b, 80c by partially squashed thin plate 80x. For example, in this embodiment, the thickness of the thin plate 80x is 0.5 mm, and the thickness of the tip portion of the sharpened convex portion 83a is 0.25 mm. It is to be noted that the dimension of the thickness of the sharpened convex portion 83a is merely one example, the thickness of the sharpened convex portion 83a is actually set in accordance with the press-fitting load between the sharpened convex portion 83a and the bobbin 81, the material, thickness, and hardness of the bobbin 81 and so on.

When the thin plates 80x are laminated to compose the stator core 21, a plurality of sharpened convex portions 83a is lined up along the lamination direction, so that a concavity and convexity are alternately created in the lamination direction due to the sharpened convex portions 83a. Accordingly, each stator tooth 80 is provided with two lines of the sharpened convex portions 83a on each of the first and second tooth side faces 80b, 80c, that is, four lines of the sharpened convex portions 83a in all.

When the bobbin 81 is assembled to the stator tooth 80, the bobbin 81 wound with the exciting coil 22 is fitted around the stator tooth 80 having four lines of the sharpened convex portions 83a. At this time, as shown in FIG. 1C, the bobbin 81 is pressed until the edge of the bobbin 81 comes into contact with an inner face of a ring portion of the stator core 21. By the above-mentioned process, the assembling of the exciting coil 22 to the stator tooth 80 is completed. That is, the assembling of the stator 12 is completed.

Next, the assembling of the stator 12 (stator core 21+exciting coil 22) to the rear housing 20 will be explained. The rear housing 20 has a plurality of stator terminals 85 and a plurality of bus bars 84 as means for supplying current to the exciting coil 22.

The plurality of stator terminals 85 is insert-molded in the rear housing 20. One end of the stator terminal 85 is exposed within a connector for external connection. The other end of the stator terminal 85 is exposed in the rear housing 20 to be electrically connected with the bus bar 84.

The plurality of bus bars 84 is supported by insulating parts made of resin and so on, which are fixed on the inner wall of the rear housing 20. The plurality of bus bars 84 is electrically connected with corresponding stator terminals 85, as described above. In addition, the plurality of bus bars 84 is formed into a pattern with which corresponding connection portions 82a of the bobbin terminals 82 come into contact when the stator 12 (assembly of the stator core 21 and exciting coil 22) is assembled to the rear housing 20.

When the stator 12 is installed at a specified position in the rear housing 20, each bus bar 84 conforms to each bobbin terminal 82. After that, when the contact portions between each bobbin terminal 82 and each bus bar 84 are connected by electrical connection means such as projection welding, the assembling of the stator 12 to the rear housing 20 is completed.

### Effects of this Embodiment

In the electric motor 5 of this embodiment, the bobbin 81 wound with the exciting coil 22 is fitted around the stator tooth 80. As shown in FIG. 1A, the thin plate 80x of the portion forming the stator tooth 80 has two convex portions 83 at each of the first and second tooth side faces 80b, 80c. By laminating the thin plates 80x, the stator tooth 80 is provided with two lines of convex portions 83 at the first tooth side face 80b and two lines of the convex portions 83 at the second tooth side face 80c. That is, the stator tooth 80 is provided with four lines of convex portions 83.

By this means, as shown in FIG. 1C, because the bobbin 81 is supported onto the stator tooth 80 by four lines of the convex portions 83, the inclination of the bobbin 81 in the rotating direction can be prevented. In addition, as shown in FIG. 1C, four lines of the convex portions 83 is press-fitted into the bobbin 81. Because a large number of the convex portions 83 is press-fitted into the bobbin 81, the strength for fixing and holding the bobbin 81 can be increased.

All of four convex portions 83 formed in the thin plate 80x are a sharpened convex portion 83a of which the tip portion has a thickness thinner than a thickness of the thin plate 80x. Therefore, by laminating the thin plates 80x, the sharpened convex portion 83a extends in a direction perpendicular to the lamination direction along which the thin plates 80x are laminated. A concavity and convexity are alternately created in the lamination direction due to the sharpened convex portions 83a. As shown in FIG. 1D, because a plurality of the sharpened convex portions 83a cut into the bobbin 81, the bobbin can be prevented from being shifted in the lamination direction. Also, because the stator tooth 80 has four lines of concavities and convexities created in the lamination direction by the sharpened convex portions 83a, the effect that the bobbin 81 is prevented from being shifted in the lamination direction is further enhanced.

In addition, as shown in FIG. 1C, the strength for fixing and holding the bobbin 81 can be increased by many sharpened convex portions 83a cutting into the bobbin 81 made of resin. That is, because all of the convex portions 83 in the four lines cut into the bobbin 81, the strength for fixing and holding the bobbin 81 can be increased.

As described above, in the electric motor 5 of this embodiment, because the stator tooth 80 is provided with four lines of convex portions 83 and many sharpened convex portions 83a lined in the lamination direction cut into the bobbin, the bobbin 81 can be assembled in a right position on the stator core 21 and the strength for fixing and holding the bobbin 81 assembled on the stator core 21 can be increased, and thereby, the position of the bobbin 81 assembled in the right position can be maintained. That is, the positions of the bobbin terminals 82 relative to the stator core 21 are held, and the bobbin terminals 82 do not move from a specified assembled position.

An overlapping width for press-fitting the bobbin 81 around the stator tooth 80 is ensured by an overlapping width between the convex portions 83 and the bobbin 81. Because the bobbin 81 is inserted along layers of the laminated thin plates 80x, smooth assembling can be realized. That is, the assembly of the bobbin 81 to the stator tooth 80 can be easily carried out.

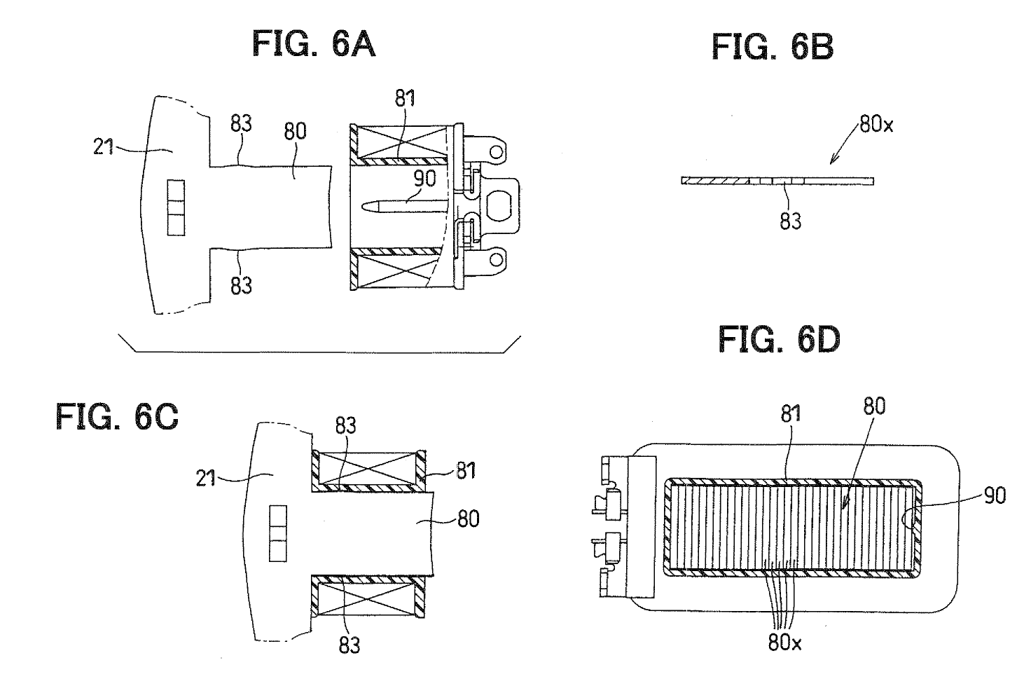

In addition, because the bobbin 81 can be prevented from being shifted in the lamination direction as the result that many sharpened convex portions 83a lined in the lamination direction cut into the bobbin 81, the stripe-shaped convex portion 90 (see FIG. 6) used in the trial product can be omitted. Therefore, there is no trouble of occurrence of resin burrs when the bobbin 81 is assembled onto the stator core 21. In this way, because resin burrs are not produced, inferior operation due to the fall of the resin burrs is not caused, and thereby, reliability of the electric motor 5 can be enhanced.

Because the sharpened convex portion 83a is formed by plastic deformation working due to pressurized press, the sharpened convex portion 83a can be formed at a low working cost.

As described above, in this embodiment, the positions of the bobbin terminals 82 relative to the stator core 21 are securely held, and the bobbin terminals 82 do not move from the specified assembled positions. As a result, when the stator 12 assembled with the bobbin 81 is installed in the rear housing 20, there is no trouble that the bobbin terminals supported by the bobbin 81 move from the specified assembled positions. For this reason, only by installing the stator core 21 in the rear housing 20, the bus bar 84 supported on the rear housing 20 conforms to the bobbin terminal 82 supported by the bobbin 81. By this means, a connection work between the bus bar 84 and the bobbin terminal 82 can be easily and reliably carried out.

In more details, the stator core 21 assembled with the exciting coil 22 is installed in the rear housing 20. The contact portions in which the bus bar 84 conforms to the bobbin terminal 82 are welded. By this means, the assembling of the stator core 21 to the rear housing 20 is completed. Accordingly, the assembling of the electric motor 5 can be made easier, and high reliability for assembling can be realized.

(Modifications)

In the embodiment described above, all of the convex portions 83 are the sharpened convex portions 83a But, at least the convex portions 83 belonging to at least one line among four lines may be the sharpened convex portions 83a. For example, the convex portions 83 belonging to two lines positioned at an outer side in the radial direction may be the sharpened convex portions 83a. Or, the convex portions 83 belonging to two lines positioned at an inner side in the radial direction may be the sharpened convex portions 83a.

In the embodiment described above, the bobbin terminal 82 is electrically connected to the bus bar 84 fixed to the inner face of the rear housing 20. However, a current supply pattern for supplying current to the exciting coil 22 may be formed on the substrate 63, and the bobbin terminal 82 may be connected to the current supply pattern of the substrate 63. Alternatively, the bobbin terminal 82 may be directly connected to the stator terminal 85 insert-molded in the rear housing 20.

In the embodiment described above, the SR motor is employed as the electric motor 5. The other motor such as a different reluctance motor (for example, synchronous reluctance motor), a permanent magnet type synchronous motor including a surface permanent magnet (SPM) type synchronous motor and an interior permanent magnet (IPM) type synchronous motor may be employed.

In the embodiment described above, although the stator teeth 80 extend toward an inward radial direction, the stator teeth 80 may extend toward an outward radial direction.

In the embodiment described above, although the electric motor 5 is employed as the rotating machine according to the present invention, a generator which generates electricity when rotating is employed as the rotating machine.

What is claimed is:

1. A rotating machine comprising:
a stator core formed by laminating many thin plates and having a plurality of stator teeth extending toward an inward or outward radial direction; and
a stator coil provided to each of the stator teeth,
wherein the stator coil is wound around a bobbin made of resin, and the bobbin is fitted around a stator tooth,
the thin plate of a portion forming the stator tooth has a tooth tip face positioned at an edge in a radial direction and extending along a rotating direction, a first tooth side face extending along the radial direction from one end of the tooth tip face, and a second tooth side face extending along the radial direction from another end of the tooth tip face,
convex portions projecting in the rotating direction and press-fitted into the bobbin are formed on the first and second tooth side faces,
two or more convex portions are formed on the first tooth side face, and one or more convex portion is formed on the second tooth side face,
at least one of the convex portions is a sharpened convex portion of which a tip portion has a thickness thinner than a thickness of the thin plate.

2. A rotating machine according to claim 1, wherein the sharpened convex portion is formed by plastic deformation working due to pressurized press.

3. A rotating machine according to claim 1, further comprising:
a stator housing for accommodating a stator composed of the stator core and the stator coil; and
bus bars supported on the stator housing for energizing the stator coil,
wherein the bobbin has bobbin terminals connected to both ends of the stator coil respectively, and
the bus bars supported on the stator housing conform to the bobbin terminals supported by the bobbin when the stator is installed in the stator housing.

4. A rotating machine comprising:
a stator core formed by laminating a plurality of thin plates and having a plurality of stator teeth extending toward an inward or outward radial direction;
a stator coil; and
bobbins made of resin, wound with the stator coil and press-fitted around each stator tooth,
wherein the thin plate of a portion forming the stator tooth has at least one convex portion projecting from each of side faces of the stator tooth in a rotating direction of the rotating machine, and the convex portion formed on at least one of the side faces is a sharpened convex portion of which a tip portion has a thickness thinner than a thickness of the thin plater so that the sharpened convex portion cuts in an inner wall of the bobbin.
